(19) United States
(12) Patent Application Publication
(10) Pub. No.: US 2021/0044428 A1
(43) Pub. Date: Feb. 11, 2021

(54) BLOCKCHAIN-BASED PERSONAL INFORMATION MANAGEMENT APPARATUS AND METHOD

(71) Applicants: ELECTRONICS AND TELECOMMUNICATIONS RESEARCH ISTITUTE, Daejeon (KR); IUCF-HYU (INDUSTRY-UNIVERSITY COOPERATION FOUNDATION HANYANG UNIVERSITY), Seoul (KR)

(72) Inventors: Jung-Yeon HWANG, Daejeon (KR); Hyun-Ok OH, Seoul (KR); Seung-Hyun KIM, Daejeon (KR); Soo-Hyung KIM, Daejeon (KR); Jeong-Hyuk LEE, Seoul (KR)

(21) Appl. No.: 16/857,556

(22) Filed: Apr. 24, 2020

(30) Foreign Application Priority Data
Aug. 8, 2019 (KR) 10-2019-0096660

(51) Int. Cl. H04L 9/08; H04L 9/06

(52) U.S. Cl. CPC H04L 9/088; H04L 9/0643

(57) ABSTRACT

A blockchain-based personal information management apparatus and method. The blockchain-based personal information management method includes recording, by a first server device, an encrypted value of personal information of a user and a hash value of the personal information in a blockchain, generating, by the first server device, a proof key to be used to generate a personal information proof of the personal information and a verification key to be used to verify the personal information proof based on the personal information, generating, by a blockchain-based personal information management apparatus, the personal information proof from values recorded in the blockchain using the proof key and a prestored prove function related to a zero-knowledge proof, and verifying, by a second server device, the personal information proof from the values recorded in the blockchain using the verification key and a prestored verify function related to the zero-knowledge proof.

### CROSS REFERENCE TO RELATED APPLICATION

This application claims the benefit of Korean Patent Application No. 10-2019-0096660, filed Aug. 8, 2019, which is hereby incorporated by reference in its entirety into this application.

### BACKGROUND OF THE INVENTION

### 1. Technical Field

The present invention relates generally to blockchain technology, and more particularly, to technology for managing personal information based on a blockchain.

### 2. Description of the Related Art

As the usefulness of personal information has recently increased, methods for providing personal information have been actively discussed. One of the most common personal information provision methods is a method that allows a group which desires to use personal information to obtain approval from each individual and then use the personal information. However, in this case, two problems may occur: one in which more information than what is required by an institution in order to utilize the personal information is currently being exposed, and the other in which a trusted party is required to provide authentication information about the corresponding requested information to a corporation every time the corporation requests personal information.

Meanwhile, Korean Patent No. 10-1946557 entitled “method and system for registering and managing gene information using blockchain” discloses a method and system which store and manage genomic information and associated additional information using a blockchain network.

### SUMMARY OF THE INVENTION

Accordingly, the present invention has been made keeping in mind the above problems occurring in the prior art, and an object of the present invention is to provide a personal information management technique that guarantees the privacy and reliability of personal information.

Another object of the present invention is to provide an easy authentication scheme that efficiently manages personal information while guaranteeing the integrity of the personal information, and that enables the personal information to be shared.

In accordance with an aspect of the present invention to accomplish the above objects, there is provided a blockchain-based personal information management method performed by a blockchain-based personal information management apparatus, the blockchain-based personal information management method including recording, by a first server device, an encrypted value of personal information of a user and a hash value of the personal information in a blockchain; generating, by the first server device, a proof key to be used to generate a personal information proof of the personal information and a verification key to be used to verify the personal information proof based on the personal information; generating, by the blockchain-based personal information management apparatus, the personal information proof from values recorded in the blockchain using the proof key and a prestored prove function related to a zero-knowledge proof; and verifying, by a second server device, the personal information proof from the values recorded in the blockchain using the verification key and a prestored verify function related to the zero-knowledge proof.

Recording the encrypted value and the hash value may be configured to generate the encrypted value of the personal information by encrypting a prestored encryption key and the personal information using a prestored register function related to the zero-knowledge proof and to generate the hash value of the personal information by hashing an identifier of the user, the personal information, and a random variable using the prestored register function related to the zero-knowledge proof.

Generating the verification key may be configured to generate the proof key and the verification key from the values recorded in the blockchain using a prestored setup function related to the zero-knowledge proof.

Generating the personal information proof may be configured to obtain the personal information by decrypting the encrypted value of the personal information from the values recorded in the blockchain, and to generate the personal information proof from the prestored prove function related to the zero-knowledge proof using the personal information, the hash value of the personal information, and the proof key.

Verifying the personal information proof may be configured to verify the personal information proof from the prestored verify function related to the zero-knowledge proof using the values recorded in the blockchain, the verification key, and the personal information proof.

In accordance with another aspect of the present invention to accomplish the above objects, there is provided a blockchain-based personal information management apparatus, including one or more processors; and an execution memory for storing at least one program that is executed by the one or more processors, wherein the at least one program is configured to generate, by a first server device, a personal information proof of personal information of a user from values recorded in a blockchain using a proof key and a prestored prove function related to a zero-knowledge proof, the proof key being used to generate the personal information proof using the personal information of the user, wherein the first server device records an encrypted value of the personal information and a hash value of the personal information in the blockchain, and generates a verification key to be used to verify the personal information proof, and wherein the personal information proof is verified by a second server device from the values recorded in the blockchain using the verification key and a verify function related

The first server device may be configured to generate the encrypted value of the personal information by encrypting a prestored encryption key and the personal information using a prestored register function related to the zero-knowledge proof and to generate the hash value of the personal information by hashing an identifier of the user, the personal information, and a random variable using the prestored register function related to the zero-knowledge proof.

The first server device may be configured to generate the proof key and the verification key from the values recorded in the blockchain using a prestored setup function related to the zero-knowledge proof.

The at least one program may be configured to obtain the personal information by decrypting the encrypted value of the personal information from the values recorded in the blockchain, and to generate the personal information proof from the prestored prove function related to the zero-knowledge proof using the personal information, the hash value of the personal information, and the proof key.

The second server device may be configured to verify the personal information proof from the prestored verify function related to the zero-knowledge proof using the values recorded in the blockchain, the verification key, and the personal information proof.

In accordance with a further aspect of the present invention to accomplish the above objects, there is provided a trusted party server device, including one or more processors; and an execution memory for storing at least one program that is executed by the one or more processors, wherein the at least one program is configured to record an encrypted value of personal information of a user and a hash value of the personal information in a blockchain, and generate a proof key to be used to generate a personal information proof of the personal information and a verification key to be used to verify the personal information proof based on the personal information, wherein the personal information proof is generated by a computing device of the user from the values recorded in the blockchain using the proof key and a prestored prove function related to a zero-knowledge proof, and wherein the personal information proof is verified by a verification authority server device from the values recorded in the blockchain using the verification key and a prestored verify function related to the zero-knowledge proof.

The at least one program may be configured to generate the encrypted value of the personal information by encrypting a prestored encryption key and the personal information using a prestored register function related to the zero-knowledge proof and to generate the hash value of the personal information by hashing an identifier of the user, the personal information, and a random variable using the prestored register function related to the zero-knowledge proof.

The at least one program may be configured to generate the proof key and the verification key from the values recorded in the blockchain using a prestored setup function related to the zero-knowledge proof.

The computing device of the user may be configured to obtain the personal information by decrypting the encrypted value of the personal information from the values recorded in the blockchain, and to generate the personal information proof from the prestored prove function related to the zero-knowledge proof using the personal information, the hash value of the personal information, and the proof key.

The verification authority server device may be configured to verify the personal information proof from the prestored verify function related to the zero-knowledge proof using the values recorded in the blockchain, the verification key, and the personal information proof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a blockchain-based personal information management system according to an embodiment of the present invention;

FIG. 2 is an operation flowchart illustrating a blockchain-based personal information management method according to an embodiment of the present invention;

FIG. 3 is a diagram illustrating a personal information proof generation algorithm using a zero-knowledge proof according to an embodiment of the present invention; and

FIG. 4 is a diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, preferred embodiments of the present invention will be described in detail with reference to the attached drawings.

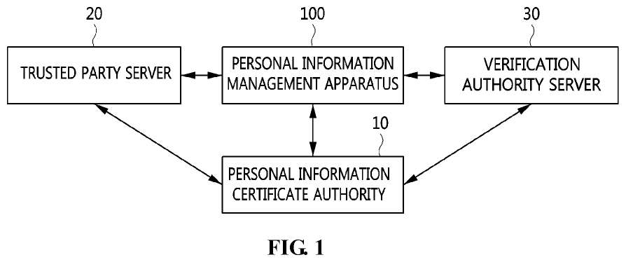

FIG. 1 is a block diagram illustrating a blockchain-based personal information management system according to an embodiment of the present invention.

Referring to FIG. 1, the blockchain-based personal information management system according to the embodiment of the present invention may include a personal information certificate authority 10, a trusted party server 20, a verification authority server 30, and a personal information management apparatus 100.

The blockchain-based personal information management system according to the embodiment of the present invention may collect personal information from a corporation through a request for a personal information collection and usage agreement.

Each corporation may show the purpose of personal information collection, information to be collected, a storage period, etc. to each individual, obtain personal information collection agreement from each individual, and request personal information from the trusted party server 20, and the trusted party server 20 may provide the corporation with the personal information for which agreement from the corresponding individual has been obtained. However, the information to be provided by each individual is determined by the corresponding corporation, and there is no method allowing each individual to check whether the corresponding information meets the purpose of collection. Even if the corporation presents a sufficient basis to each individual, the basis for personal information collection provided by the corporation is based only on laws. Accordingly, this is disadvantageous in that there is no method of allowing each individual to check a procedure for actually processing the personal information, and thus each individual has no choice but to trust the corporation.

That is, an individual must inevitably provide his or her personal information without doubt in response to a personal information request provided by the corporation. Further, there are many cases where agreements pertaining to storage periods for the personal information, collected as described above, are not respected, and such violation of storage periods is prohibited under law. Thus, from the standpoint of the corporation, there definitely occurs the possibility of continuing to store each individual's personal information by evading the law. Therefore, there is required a new approach to the provision of personal information because provision of personal information to the corporation without change, as in the case of current systems, may cause a privacy problem.

As a method for managing personal information requiring authentication, the personal information certificate authority 10 individually stores personal information in a server, and an individual may request personal information requiring authentication from the personal information certificate authority 10.

Storage of the personal information in the server of the single personal information certificate authority 10 entails a risk of falsification of the information stored in the server when the server is attacked by a malicious attacker and management authority is stolen. Also, the personal information certificate authority 10 may rebuild the entire server and duplicate information, or may request data from a server administrator and use the data in order to share data when managing personal information in the server. In this case, rebuilding the entire server of the personal information certificate authority 10 and duplicating information is not efficient from the standpoint of expenses. Further, requesting data from the server administrator and using the data, as in the case of current systems, is limited in that it is possible only when the server administrator is completely trusted.

Therefore, in the personal information certificate authority 10 according to an embodiment of the present invention, a component for personal information management is configured as a blockchain rather than a single server.

Also, the blockchain-based personal information management apparatus 100 according to an embodiment of the present invention may provide a privacy-protective personal information management technique using a zero-knowledge proof technique together with blockchain technology so as to perform personal information management.

A zero-knowledge Succinct Non-interactive ARgument of Knowledge (zk-SNARK), which is a zero-knowledge proof algorithm, is technology for proving the correctness of a statement without revealing any secret information. zk-SNARK may enable zero-knowledge proofs, and, in particular, generated proofs may have a size less than or equal to log (N) of a proof equation (N).

Also, there is no interaction between a prover and a verifier, and only a person having knowledge can generate proofs. zk-SNARK may configure a specific function using a circuit composed of a single multiplication and multiple additions, and may create a common variable, that is, a common reference string (CRS), for a single function by configuring circuit data using a Rank-1 Constraint System (R1CS) and thereafter producing R1CS data in the form of a Quadratic Arithmetic Program (QAP) or Square Arithmetic Program (SAP).

Also, as the zero-knowledge proof algorithm, there is a Non-Interactive Zero Knowledge Arguments of Knowledge (NIZK) algorithm.

Assuming that R is a relation generator, four Non-Interactive Zero-Knowledge Arguments of Knowledge (NIZK) algorithms, namely Setup, Prove, Verify, and SimProve algorithms, may satisfy perfect completeness, computational soundness, and zero-knowledge.

The four algorithms may be individually defined as follows.

The Setup algorithm may receive relation R as input, and may output a common reference string crs and a simulation trapdoor τ.

(crs, r)←Setup(R)

The Prove algorithm may receive, as input, the common reference string crs for the relation R and (ϕ, ω) ∈ R, and may output a proof π.

π←Prove(crs, ϕ; ω)

The Verify algorithm may receive, as input, the common reference string crs, the instance ϕ, and the proof π, and may output ‘1’ when the proof π is correct, and output ‘0’ when the proof π is incorrect.

0/1←Verify(crs,ϕ,π)

The simulator SimProve algorithm may receive, as input, the common reference string crs, the simulation trapdoor τ, and the instance ϕ, and may output the proof π.

π←SimProve(crs,τ,ϕ)

R: Relation

crs: common variable (common reference string)

τ: trapdoor

π: proof

ϕ: instance

Further, the algorithms for personal information management based on a blockchain according to an embodiment of the present invention may provide an algorithm in which multiple entities are present, as illustrated in FIG. 1.

That is, the blockchain-based personal information management system according to the embodiment of the present invention may include the personal information certificate authority 10, which records personal information in a block and manages the personal information as a blockchain, a trusted party server 20, which records the personal information in a blockchain, the personal information management apparatus (individual entity) 100, which processes the personal information in conformity with the needs of a corporation and generates proofs, and the verification authority server 30, which is a corporation for verifying the processed data received from each individual.

Further, the algorithms proposed in the present invention use zk-SNARK, and zk-SNARK used therein may be designated by ‘Verifiable Computing’.

The algorithms proposed in the present invention may be represented as follows.

A ChainSetup(k) algorithm may be an algorithm executed by the trusted party server 20. This algorithm may receive, as input, a security parameter k and generate an initial block (genesis block) of a blockchain, and may set up the authority to access the blockchain and the authority to register a block.

A Register (ID, info, pk_{ID}) algorithm may be an algorithm executed by the trusted party server 20. This algorithm may output ciphertext CT generated by receiving, as input, an ID, personal information info for the ID, and an encryption key pk_{ID} for encryption and by encrypting the personal information info using the pk_{ID}, may output a hash value h obtained by receiving, as input, the personal information info and by performing a hash operation on the info and a random variable r for randomization, may output the ID, and may record ID, CT, and h in the blockchain. At this time, the ID, CT, and h that are recorded may be defined as tx, and tx may be recorded in the blockchain.

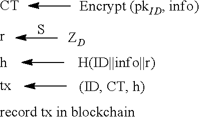

A Setup(f) algorithm may be an algorithm executed by the trusted party server 20. This algorithm may define the relation R by receiving, as input, the function f, may invoke a Setup_{VC} function related to NIZK, and may generate and output a proof key ek_{f} and a verification key vk_{f} to be used for proof and verification, wherein ek_{f} and vk_{f} are generated by receiving, as input, the function f, which utilizes the personal information in order to generate personal information proofs.

$$R = \{ \begin{matrix}( φ , w ) , \\ φ = ( tx , t ) , w = ( info , r ) , ix = ( ID , CT , h ) , \\ t = f ( ID \vert \vert info ) , h = H ( ID ‖ info ‖ r ) \end{matrix} \}$$

$$( {ek}_{f} , {vk}_{f} ) ← {Setup}_{VO} ( R )$$

$$return {ek}_{f} , {vk}_{f}$$

A ProvePI(tx,sk_{ID},ek_{f},f) algorithm may be an algorithm executed by the personal information management apparatus (individual entity) 100. This algorithm may receive, as input, tx composed of the ID, the ciphertext CT, and the hash value h, a secret key sk_{ID} to be used to decrypt the ciphertext, the proof key ek_{f} for the function f, and the function f and may obtain the personal information info and the random variable r by decrypting the personal information ciphertext CT fetched from the blockchain before the proof is generated.

Thereafter, the personal information management apparatus 100 may receive, as input, the ID and the personal information info, and may obtain a resultant value t for the function f.

Here, after the resultant value t has been obtained, the personal information management apparatus 100 may set the proof key ek_{f} and the function f as the crs, may set tx and t as the instance ϕ, may execute the Prove function Prove_{VC} related to zk-SNARK, and may then output the proof π and the function resultant value t.

Here, the Prove_{VC} function may generate the proof π by checking t=f(ID, info) and h=H(ID∥info∥r).

(info,r)←Decrypt(sk_{ID},CT)

t←f(ID,info)

σs(f,ek_{f}), ϕ←(tx,t), ω←(info,r)

π←Prove_{VC}(σs,ϕω)

return t,π

A VerifyPI(vk_{f},tx,t,π) algorithm may be an algorithm executed by the verification authority server 30, which is a corporation. This algorithm may receive, as input, the proof output from the Prove function, the verification key vk_{f}, tx, which is a set of the ID, the CT, and the personal information hash value h, the output t of the function f, and the proof π, may set vk_{f} and f as the crs and set tx and t as the instance ϕ, may execute a Verify_{VC} function, and may then verify the proof π, generated from the Prove_{VC} function. Here, when the result of verification is ‘1’, the verification value may, be returned, whereas when the result of verification is ‘0’, ‘⊥’ may be returned.

σs←(f,vk_{f}) ϕ←(tx,t)

b←Verify_{VC}(crs,ϕ,π)

if b=1 return b

if b=0 return ⊥

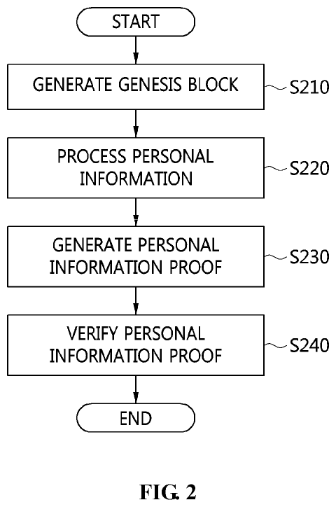

FIG. 2 is an operation flowchart illustrating a blockchain-based personal information management method according to an embodiment of the present invention.

Referring, to FIG. 2, in the blockchain-based personal information management method according to the embodiment of the present invention, an initial block (genesis block) may be generated at step S210.

That is, at step S210, an initial block (genesis block) to be recorded in the blockchain of the personal information certificate authority 10 may be generated by receiving, as input, a security parameter k.

Next, in the blockchain-based personal information management method according to the embodiment of the present invention, personal information may be processed at step S220.

That is, at step S220, the trusted party server 20 may use personal information encryption and a hash function to process the personal information of the user, and may record an encrypted value of the personal information of the user and a hash value of the personal information in the blockchain.

At step S220, the encrypted value of the personal information may be generated by encrypting a prestored encryption key and the personal information using a prestored register function (Register) related to a zero-knowledge proof, and the hash value of the personal information may be generated by hashing (i.e., by performing a hash operation on) the user's ID, the personal information, and the random variable.

Here, at step S220, a proof key to be used to generate a personal information proof of the personal information and a verification key to be used to verify the personal information proof may be generated based on the personal information.

Here, at step S220, the proof key and the verification key may be generated from the values recorded in the blockchain using a prestored setup function (Setup) related to the zero-knowledge proof

At step S230, the personal information proof may be generated from the values recorded in the blockchain using the proof key and a prestored prove function (ProvePI) related to the zero-knowledge proof.

Here, at step S230, the personal information may be acquired by decrypting the encrypted value of the personal information from the values recorded in the blockchain, and the personal information proof may be generated from the prestored prove function related to the zero-knowledge proof using the personal information, the hash value of the personal information, and the proof key.

At step S240, the verification authority server 30 may verify the personal information proof from the values recorded in the blockchain using the verification key and a prestored verify function (VerifyPI) related to the zero-knowledge proof.

Here, at step S240, the personal information proof may be verified from the prestored verify function related to the zero-knowledge proof using the values recorded in the blockchain, the verification key, and the personal information proof.

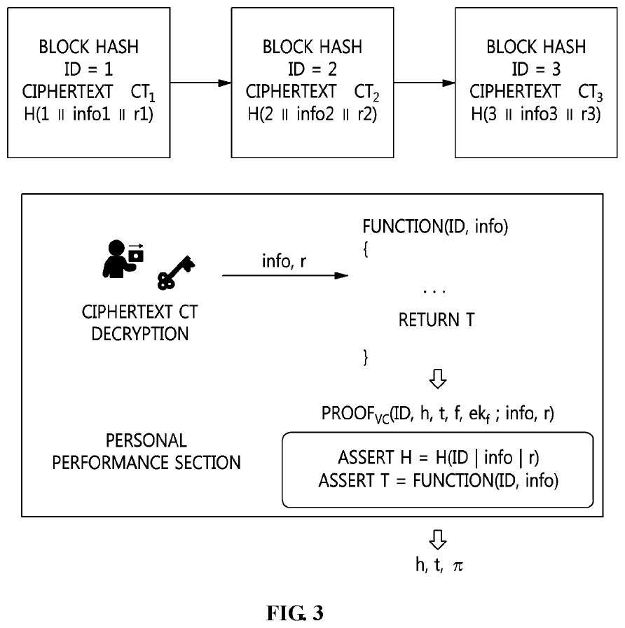

FIG. 3 is a diagram illustrating a personal information proof generation algorithm according to an embodiment of the present invention.

Referring to FIG. 3, in the personal information proof generation algorithm according to the embodiment of the present invention, an individual or a personal information certificate authority may initially encrypt personal information info and a random variable r, required for hash calculation, record the encrypted result in a blockchain, and record a hash value H(ID∥info∥r) obtained by hashing the personal information, together with ciphertext CT, in the blockchain so as to prove the personal information when the personal information is used later.

Here, r may be a random variable added for security of the hash value. Also, for respective users, different values may be assigned to the random variable r.

Thereafter, when the time point at which the personal information is to be utilized is reached, each user may decrypt the ciphertext in a personal performance section, and may execute a function f for utilizing the personal information by receiving, as input, the personal information info, obtained through decryption, and the ID.

Thereafter, in order to prove the result of execution of the function, hash data for personal information may be fetched from the blockchain, and may be used as the input of the proof.

Here, a prove function is intended to prove two items. A first item is to prove whether the value of H(ID∥info∥r) used as input is a value generated through an actual value, and a second item is to prove whether the function result t is a value generated through the personal information info.

That is, the prove function may generate a proof for the function execution result t by receiving, as input, the function execution result t and the hash data H(ID∥info∥r) for the personal information.

When the generation of the proof is completed, the individual presents his or her proof and the function execution result to a personal information usage institution, thus being guaranteed with the reliability of the personal information.

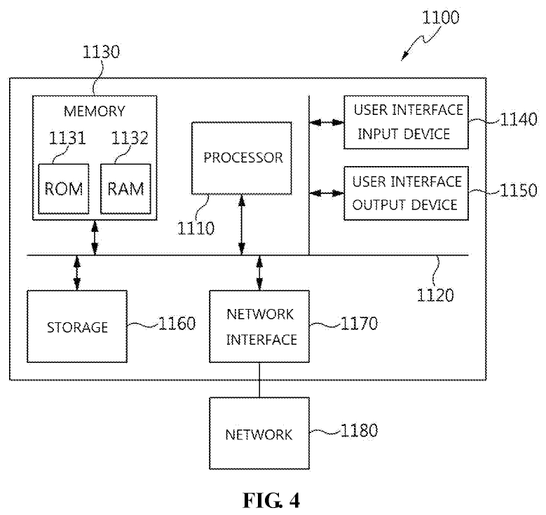

FIG. 4 is a diagram illustrating a computer system according to an embodiment of the present invention.

Referring to FIG. 4, a trusted party server 20, a verification authority server 30, multiple blockchain nodes included in a personal information certificate authority 10, and a blockchain-based personal information management apparatus 100 according to an embodiment of the present invention may be implemented in a computer system 1100, such as a computer-readable storage medium. As illustrated in FIG. 4, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RANI) 1132.

The blockchain-based personal information management apparatus 100 may include one or more processors 1110 and execution memory 1130 for storing at least one program executed by the one or more processors 1110.

Further, the trusted authority server 20 may include one or more processors and execution memory for storing at least one program executed by the one or more processors.

Furthermore, the verification authority server 30 may include one or more processors and execution memory for storing at least one program executed by the one or more processors.

Here, the at least one program of the trusted authority server 20 may generate an initial block (genesis block) to be recorded in the blockchain of the personal information certificate authority 10 by receiving, as input, a security parameter k.

Here, the at least one program of the trusted authority server 20 may use personal information encryption and a hash function to process the personal information of the user, and may record an encrypted value of the personal information of the user and a hash value of the personal information in the blockchain.

Here, the at least one program of the trusted authority server 20 may generate the encrypted value of the personal information by encrypting a prestored encryption key and the personal information using a prestored register function (Register) related to a zero-knowledge proof, and may generate the hash value of the personal information by hashing the user's ID, the personal information, and the random variable.

Here, the at least one program of the trusted authority server 20 may generate a proof key to be used to generate a personal information proof of the personal information and a verification key to be used to verify the personal information proof based on the personal information.

Here, the at least one program of the trusted authority server 20 may generate the proof key and the verification key from the values recorded in the blockchain using a prestored setup function (Setup) related to the zero-knowledge proof.

Here, the at least one program of the blockchain-based personal information management apparatus 100 may generate the personal information proof from the values recorded in the blockchain using the proof key and a prestored prove function (ProvePI) related to the zero-knowledge proof.

Here, the at least one program of the blockchain-based personal information management apparatus 100 may acquire the personal information by decrypting the encrypted value of the personal information from the values recorded in the blockchain, and may generate the personal information proof from the prestored prove function related to the zero-knowledge proof using the personal information, the hash value of the personal information, and the proof key.

Here, the at least one program of the verification authority server 30 may verify the personal information proof from the values recorded in the blockchain using the verification key and a prestored verify function (VerifyPI) related to the zero-knowledge proof.

Here, the at least one program of the verification authority server 30 may verify the personal information proof from the prestored verify function related to the zero-knowledge proof using the values recorded in the blockchain, the verification key, and the personal information proof.

The blockchain-based personal information management apparatus and method according to embodiments of the present invention are advantageous in that, unlike a conventional scheme in which each individual provides his or her personal information to a corporation and the corporation discards the personal information after a predetermined period has elapsed, each individual may process his or her personal information in conformity with the needs of the corporation, provide the processed personal information, and additionally provide proof of the processed information, thus allowing each individual to reliably provide partial personal information without revealing private information to the corporation.

Further, the blockchain-based personal information management apparatus and method according to embodiments of the present invention are advantageous in that only partial personal information required by a corporation, rather than entire personal information, is provided as processed information, and thus the corporation cannot use personal information in a way diverging from the intended usage purpose of the personal information, as in the case of current systems, with the result that damage caused by the leakage of personal information, which currently occurs, may be greatly reduced.

Furthermore, the blockchain-based personal information management apparatus and method according to embodiments of the present invention are advantageous in that personal information is hashed and encrypted and encrypted personal information is recorded in a blockchain, so that it is difficult to falsify the recorded encrypted data and hash data, thus guaranteeing integrity from the standpoint of data management, and further facilitating access to the personal information, compared to existing server-based personal information management technology from the standpoint of accessibility to the encrypted data and hash data.

The present invention may provide a personal information management technique that can guarantee privacy and the reliability of personal information.

Further, the present invention may provide an easy authentication scheme that may efficiently manage personal information while guaranteeing the integrity of the personal information, and may enable the personal information to be shared.

As described above, in the blockchain-based personal information management apparatus and method according to the present invention, the configurations and schemes in the above-described embodiments are not limitedly applied, and some or all of the above embodiments can be selectively combined and configured such that various modifications are possible.

What is claimed is:

1. A blockchain-based personal information management method performed by a blockchain-based personal information management apparatus, the blockchain-based personal information management method comprising:
recording, by a first server device, an encrypted value of personal information of a user and a hash value of the personal information in a blockchain;
generating, by the first server device, a proof key to be used to generate a personal information proof of the personal information and a verification key to be used to verify the personal information proof based on the personal information;
generating, by the blockchain-based personal information management apparatus, the personal information proof from values recorded in the blockchain using the proof key and a prestored prove function related to a zero-knowledge proof; and
verifying, by a second server device, the personal information proof from the values recorded in the blockchain using the verification key and a prestored verify function related to the zero-knowledge proof.

2. The blockchain-based personal information management method of claim 1, wherein recording the encrypted value and the hash value is configured to generate the encrypted value of the personal information by encrypting a prestored encryption key and the personal information using a prestored register function related to the zero-knowledge proof and to generate the hash value of the personal information by hashing an identifier of the user, the personal information, and a random variable using the prestored register function related to the zero-knowledge proof.

3. The blockchain-based personal information management method of claim 1, wherein generating the verification key is configured to generate the proof key and the verification key from the values recorded in the blockchain using a prestored setup function related to the zero-knowledge proof.

4. The blockchain-based personal information management method of claim 1, wherein generating the personal information proof is configured to obtain the personal information by decrypting the encrypted value of the personal information from the values recorded in the blockchain, and to generate the personal information proof from the prestored prove function related to the zero-knowledge proof using the personal information, the hash value of the personal information, and the proof key.

5. The blockchain-based personal information management method of claim 4, wherein verifying the personal information proof is configured to verify the personal information proof from the prestored verify function related to the zero-knowledge proof using the values recorded in the blockchain, the verification key, and the personal information proof.

6. A blockchain-based personal information management apparatus, comprising:
one or more processors; and
an execution memory for storing at least one program that is executed by the one or more processors,
wherein the at least one program is configured to generate, by a first server device, a personal information proof of personal information of a user from values recorded in a blockchain using a proof key and a prestored prove function related to a zero-knowledge proof, the proof key being used to generate the personal information proof using the personal information of the user,
wherein the first server device records an encrypted value of the personal information and a hash value of the personal information in the blockchain, and generates a verification key to be used to verify the personal information proof, and
wherein the personal information proof is verified by a second server device from the values recorded in the blockchain using the verification key and a verify function related to the zero-knowledge proof.

7. The blockchain-based personal information management apparatus of claim 6, wherein the first server device is configured to generate the encrypted value of the personal information by encrypting a prestored encryption key and the personal information using a prestored register function related to the zero-knowledge proof and to generate the hash value of the personal information by hashing an identifier of the user, the personal information, and a random variable using the prestored register function related to the zero-knowledge proof.

8. The blockchain-based personal information management apparatus of claim 6, wherein the first server device is configured to generate the proof key and the verification key from the values recorded in the blockchain using a prestored setup function related to the zero-knowledge proof.

9. The blockchain-based personal information management apparatus of claim 6, wherein the at least one program is configured to obtain the personal information by decrypting the encrypted value of the personal information from the values recorded in the blockchain, and to generate the personal information proof from the prestored prove function related to the zero-knowledge proof using the personal information, the hash value of the personal information, and the proof key.

10. The blockchain-based personal information management apparatus of claim 9, wherein the second server device is configured to verify the personal information proof from the prestored verify function related to the zero-knowledge proof using the values recorded in the blockchain, the verification key, and the personal information proof.

11. A trusted party server device, comprising:
one or more processors; and
an execution memory for storing at least one program that is executed by the one or more processors,
wherein the at least one program is configured to record an encrypted value of personal information of a user and a hash value of the personal information in a blockchain, and generate a proof key to be used to generate a personal information proof of the personal information and a verification key to be used to verify the personal information proof based on the personal information,
wherein the personal information proof is generated by a computing device of the user from the values recorded in the blockchain using the proof key and a prestored prove function related to a zero-knowledge proof, and
wherein the personal information proof is verified by a verification authority server device from the values recorded in the blockchain using the verification key and a prestored verify function related to the zero-knowledge proof.

12. The trusted party server device of claim 11, wherein the at least one program is configured to generate the encrypted value of the personal information by encrypting a prestored encryption key and the personal information using a prestored register function related to the zero-knowledge proof and to generate the hash value of the personal information by hashing an identifier of the user, the personal information, and a random variable using the prestored register function related to the zero-knowledge proof.

13. The trusted party server device of claim 11, wherein the at least one program is configured to generate the proof key and the verification key from the values recorded in the blockchain using a prestored setup function related to the zero-knowledge proof.

14. The trusted party server device of claim 11, wherein the computing device of the user is configured to obtain the personal information by decrypting the encrypted value of the personal information from the values recorded in the blockchain, and to generate the personal information proof from the prestored prove function related to the zero-knowledge proof using the personal information, the hash value of the personal information, and the proof key.

15. The trusted party server device of claim 14, wherein the verification authority server device is configured to verify the personal information proof from the prestored verify function related to the zero-knowledge proof using the values recorded in the blockchain, the verification key, and the personal information proof.
